(19) United States
(12) Patent Application Publication
(10) Pub. No.: US 2019/0041874 A1
(43) Pub. Date: Feb. 7, 2019

(54) METHOD FOR ANTICIPATING THE DISPLACEMENT OF A WAKE VORTEX IN A FORMATION FLIGHT OF TWO AIRCRAFT

(71) Applicant: Airbus Operations (S.A.S.), Toulouse (FR)

(72) Inventors: Jean-luc Robin, Saint-Jean (FR); José Torralba, Merville (FR); Julie Lebas, Toulouse (FR)

(21) Appl. No.: 16/051,057

(22) Filed: Jul. 31, 2018

(30) Foreign Application Priority Data
Aug. 3, 2017 (FR) 1757446

(51) Int. Cl. G05D 1/10; B64C 13/18

(52) U.S. Cl. CPC G05D 1/104; G01W 1/02; B64C 13/18

(57) ABSTRACT

A method for anticipating displacement of a wake vortex from a leading aircraft, implemented by a flight management system of a following aircraft, flying in the wake of the leading aircraft. The method establishes formation flight, in which the flight management system defines a flight plan in which the following aircraft flies and places itself at a predetermined distance from a center of a wake vortex. In a step of reception of inertial parameters, a flight management system of the following aircraft formulates a request for inertial parameters of the leading aircraft and receives, via exchange of signals, the inertial parameters of the leading aircraft. In a decision-making step, the flight management system assesses possibility of trajectory of the following aircraft crossing that of the wake vortex and modifies the following aircraft flight plan if it estimates that the trajectory of the following aircraft crosses that of a wake vortex.

### CROSS-REFERENCE TO RELATED APPLICATION

This patent application claims priority to French patent application FR 17 57446, filed on Aug. 3, 2017, the entire disclosure of which is incorporated by reference herein.

### TECHNICAL FIELD

The disclosure herein relates to a method applicable to a formation flight of two aircraft comprising a followed aircraft, called leading aircraft, and a following aircraft which flies behind the leading aircraft. The implementation of the method allows the following aircraft to avoid crossing a wake vortex generated by the leading aircraft following a maneuver thereof.

### BACKGROUND

The leading aircraft generates, in its wake, at each of its wings, a wake vortex. From the wings, the wake vortexes tend first of all to approach one another, then to maintain a more or less constant distance between them while losing altitude relative to the altitude at which they were generated.

It is advantageous for the following aircraft to be able to compute the positions of the centers of the wake vortexes generated by the leading aircraft in order to place itself laterally at an optimal distance from the center of a vortex such that it profits most from the up draughts of the vortexes in order to reduce its fuel consumption. This optimal distance, measured between the wing end of the following aircraft and the center of the vortex, is greater than 10 m. By placing itself within this optimal distance, the following aircraft will, on the contrary, be subject to turbulences that are disagreeable to the comfort of the passengers, all the more powerful when the fuselage of the following aircraft approaches the center of the vortex.

During a formation flight, it may be that the leading aircraft turns or undergoes a vertical acceleration, for example because of atmospheric disturbances (winds, turbulences, etc.). Now, the successive positions of the centers of the vortexes generated by the leading aircraft will follow the movement of the leading aircraft, with a displacement amplitude dependent on their distance to the leading aircraft.

In order for the following aircraft not to cross the center of a wake vortex following a maneuver of the leading aircraft, the trajectory of the following aircraft has to be able to anticipate the displacement of the wake vortex centers (that is to say the trajectory of the vortexes) following the maneuver of the leading aircraft.

### SUMMARY

An object of the disclosure herein is to wholly or partly address this need and relates to a method for anticipating the displacement of a wake vortex generated by an aircraft, called leading aircraft, the method being implemented by a flight management system embedded in an aircraft, called following aircraft, flying in the wake of the leading aircraft, the flight management system being configured to compute a trajectory and define a flight plan of the following aircraft from flight parameters of the aircraft, and compute the position of the centers of the wake vortexes from flight parameters of the leading aircraft, the method comprising the following successive steps:
a step of establishing formation flight, in which the flight management system of the following aircraft defines a flight plan in which the following aircraft flies at a predetermined distance from the leading aircraft and places itself at a predetermined distance from a center of a wake vortex;
a step of reception of inertial parameters, in which the flight management system of the following aircraft formulates a request for inertial parameters of the leading aircraft and receives, via an exchange of signals between the leading aircraft and the following aircraft, the inertial parameters of the leading aircraft; and
a decision-making step, in which the flight management system of the following aircraft assesses a possibility of the trajectory of the following aircraft crossing the trajectory of the wake vortex:
   if the flight management system estimates that the trajectory of the following aircraft crosses that of the wake vortex, the flight management system modifies the flight plan so that the following aircraft avoids the wake vortex.

Thus, by virtue of the disclosure herein, the passengers of a following aircraft flying in formation behind a leading aircraft retain an optimal comfort even when the leading aircraft undertakes a maneuver (deliberate maneuver as a result, for example, of following or modifying the flight plan, or involuntary maneuver as a result, for example, of turbulences/winds) which will modify the trajectories of the wake vortexes that it generates.

### BRIEF DESCRIPTION OF THE DRAWINGS

The features of the disclosure herein mentioned above, and others, will become more clearly apparent on reading the following description of exemplary embodiments, the description being given in relation to the attached, example figures:

FIG. 1 is a schematic representation of an aircraft comprising a plurality of embedded systems allowing the implementation of a method for anticipating the displacement of the wake vortexes according to the disclosure herein;

FIG. 2 is a schematic representation of a detail of a collision avoidance system embedded in an aircraft of FIG. 1;

FIGS. 3a to 3c are schematic representations at different instants of a formation of two aircraft as illustrated in FIG. 1, including a leading aircraft generating wake vortexes turning to its right (FIG. 3b) and a following aircraft flying in formation in the wake of the leading aircraft and implementing the method for anticipating the displacement of the wake vortexes according to the disclosure herein;

FIG. 4 is a schematic view of the steps of the method for anticipating the displacement of wake vortexes implemented by a following aircraft flying in formation with an aircraft as represented in FIGS. 3a-3c, according to an embodiment of the disclosure herein; and

FIG. 5 is a schematic view of the steps of the method for anticipating the displacement of wake vortexes implemented by a following aircraft flying in formation with an aircraft as represented in FIGS. 3a-3c, according to another embodiment of the disclosure herein.

### DETAILED DESCRIPTION

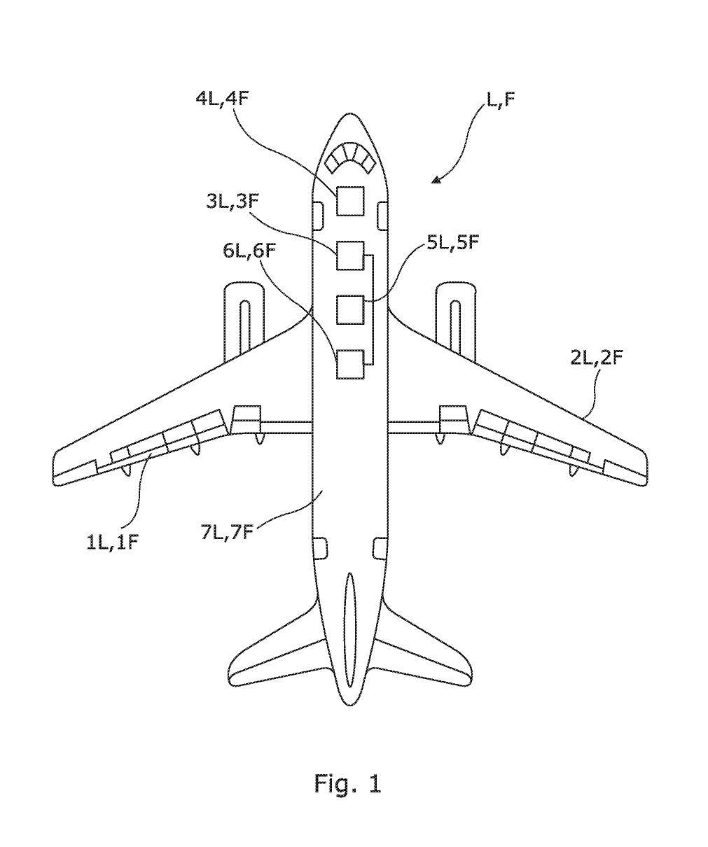

In relation to FIG. 1, an aircraft L, F comprises two wings 1L, 2L, and a plurality of systems embedded in its fuselage 7L, 7F, including a flight management system 3L, 3F of embedded computer type to define the flight plan of the aircraft, a piloting aid system 4L, 4F for aiding the pilot in following the flight plan, an inertial reference system 5L, 5F of ADIRS (Air Data Inertial Reference System) type, and a collision avoidance system 6L, 6F for preventing any risk of collisions with other aircraft.

The piloting aid 4L, 4F, inertial reference 5L, 5F and collision avoidance 6L, 6F systems are connected to the flight management systems 3L, 3F.

The flight management system 3L, 3F is connected to the inertial reference system from which it receives different inertial parameters of the aircraft (heading, roll angle, lateral inclination angle of the aircraft, trim, sideslip angle, etc.) and to a plurality of sensors of the aircraft (not represented) from which it receives flight parameters of the aircraft (altitude, weight of the aircraft, air density at the point of flight, acceleration, speed, etc.). On the basis of these various parameters, the flight management system 3L, 3F is configured to compute the trajectory of the aircraft L, F.

The flight management system 4L, I, in addition to the management/definition of the flight plan of the aircraft L, F, is configured to compute the position of the centers of each wake vortex generated by another aircraft from the flight parameters of the aircraft.

The position of the centers of the wake vortexes generated by an aircraft is obtained by the computation of the rate of descent Wv of the vortexes which is, for example, computed with the following relationship:

$${w}_{v} = \frac{m \cdot g \cdot {n}_{2}}{2 \cdot π \cdot ρ \cdot V \cdot {b}_{v}^{2}}$$

in which:
m is the weight of the aircraft generating the vortexes (kg),
g is the acceleration of gravity (m/s²),
ρ is the air density at the point of flight (kg·m−3),
V is the air speed of the aircraft generating the vortexes (m·s—1),
bv is the spacing between the two vortexes (m)=wing span of the aircraft generating the vortexes,
nz is the load factor undergone by the aircraft.

The piloting aid system 4L, 4F can be activated by the pilot who selects the mode of operation of the system between:
an automatic piloting mode in which the piloting aid system 4L, 4F, by virtue of a set of servocontrols, controls the aircraft L, F in order for the latter to follow the flight plan supplied by the flight management system 3L, 3F;
a flight director mode in which the piloting aid system 4L, 4F provides the pilot with a graphic aid displayed on one of the screens of the cockpit (not represented), in order to guide him or her in the maneuvers to be performed for the aircraft to follow the flight plan supplied by the flight management system 3L, 3F.

It will be noted that, in the execution of a formation flight, the pilot necessarily activates the piloting aid system in one or other of these two modes of operation in order to aid him or her in the piloting of the aircraft L, F.

As is known, the collision avoidance system 6L, 6F alerts the crew of the aircraft L, F to probabilities of collisions with other aircraft flying within a surveillance volume distributed around (over 360°) the aircraft and whose dimensions are dependent on the speed of the aircraft L, F.

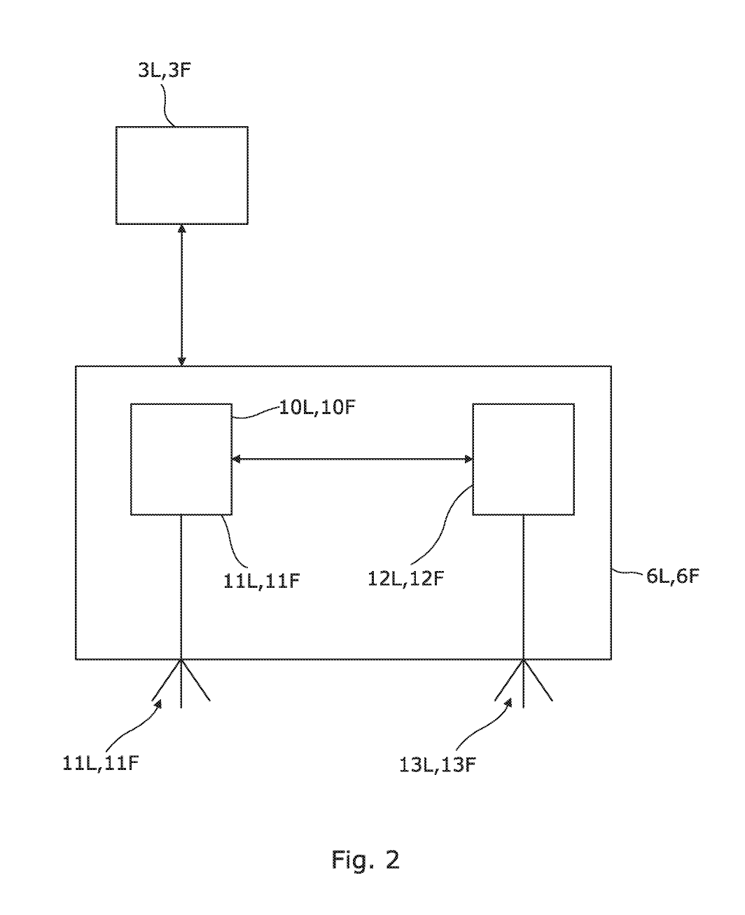

Referring to FIG. 2, the collision avoidance system 6L, 6F is an active device of TCAS (Traffic Collision Avoidance System) type and comprises, to this end:
an interrogator 10L, 10F, of central processing unit type, connected to at least one directional antenna 11L, 11F, called interrogator antenna, mounted on the aircraft;
a transponder 12L, 12F (or XPDR in aeronautical terminology), of central processing unit type, connected to at least one antenna 13L, 13F, for example omnidirectional, called transponder antenna, mounted on the aircraft.

In the principle of operation of the active devices of TCAS type, the interrogator 10F of a following aircraft F transmits interrogation signals at a fixed frequency of 1030 MHz and at regular intervals (for example every second).

The transponder 12L of a leading aircraft L receiving an interrogation signal responds by transmitting a response signal to the following aircraft F. The response signal contains the identifiers of the leading aircraft L and allows the flight management system 3F of the following aircraft to estimate, after analysis of the signal, a time of collision and to take measures to eliminate any risk of collision.

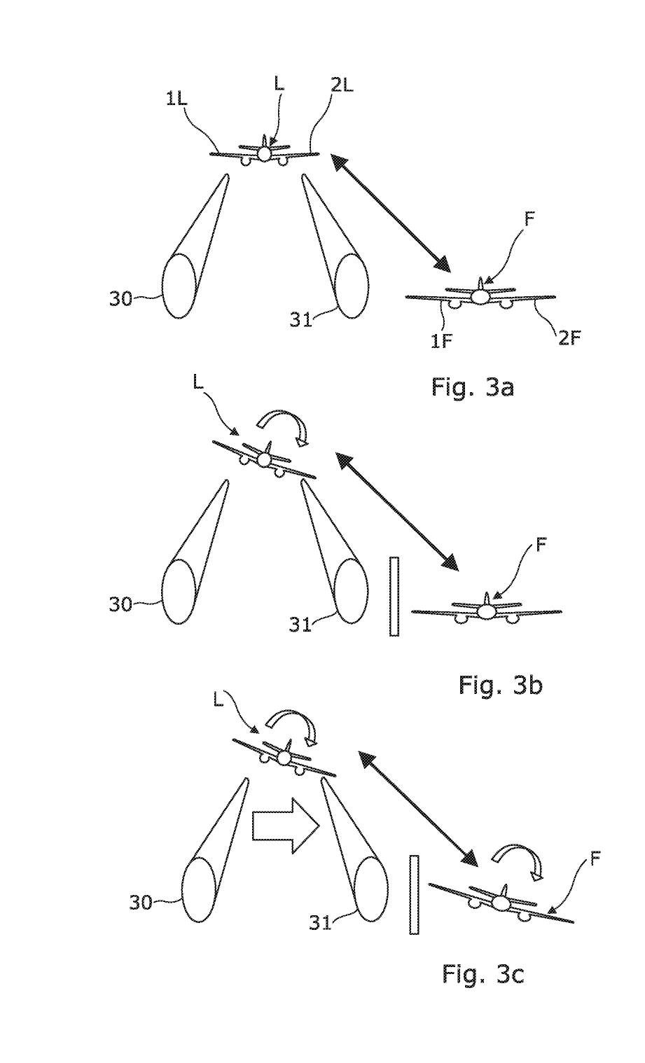

The method according to the disclosure herein, allowing a following aircraft to avoid crossing wake vortexes generated by a leading aircraft, will be explained in relation to FIGS. 3a-c and 4.

An aircraft L is considered, called leading aircraft, generating, at each of its two wings 1L, 2L, a wake vortex 30, 31 (respectively port for the wake generated at the left wing 1L—and starboard for the wake generated at the right wing 2L) and a following aircraft F flying in the wake of the leading aircraft L. Each of the leading L or following F aircraft is equipped as described above. The references in the figures bear the suffix L for the leading aircraft, or F for the following aircraft.

In the example illustrated in FIGS. 3a-3c, the following aircraft F is in the initial position (FIG. 3a) then begins a turn to the right in FIGS. 3b and 3c.

In a step of establishing formation flight E1, the flight management system 3F of the following aircraft F defines a flight plan for the piloting aid system 4F of the following aircraft to bring the following aircraft F to a predetermined distance from the leading aircraft L and place it at a predetermined distance from a center of one of the wake vortexes (for example the starboard wake vortex 31 as illustrated in FIGS. 3a-c). Following the implementation of this step, the following aircraft F benefits from the up draughts from the wake vortex. As an example, following the implementation of this step, the following aircraft F has its left wing situated at a lateral distance (greater than 10 m and less than 100 m) from the center of the starboard wake vortex 31, and flies at a distance lying between approximately 0.8 NM (0.8 nautical miles=1481.6 km) and 1.8 NM (1.8 nautical miles=3333.6 km) from the leading aircraft L;

In a step of reception of inertial parameters E2, implemented at a regular frequency, the flight management system 3F of the following aircraft F formulates a request for inertial parameters to the leading aircraft L and receives, via an exchange of signals between the collision avoidance system of the following aircraft and that of the leading aircraft 6L, 6F, the inertial parameters of the leading aircraft L.

In detail, the step of reception of inertial parameters E2 comprises:
an interrogation substep E2a, in which the interrogator 10F of the following aircraft F periodically transmits, via the interrogator antenna 11F, an interrogation signal, on 1030 MHz for example, in each of the four 90° azimuth segments. The interrogation signal transmitted contains the address of the leading aircraft L and a request for inertial parameters of the leading aircraft L formulated by the flight management system 3F of the following aircraft F; and
a transmission substep E2b, in which the transponder 12L of the leading aircraft L, flying in the surveillance volume of the following aircraft, receives the interrogation signal from the following aircraft F via the interrogator antenna 11L then sends, via the transponder antenna 13L, a response signal to the interrogator 10F of the following aircraft F, on 1090 MHz for example, in response to the interrogation signal from the following aircraft F. The response signal consists of or comprises a series of pulses which contain identifiers of the leading aircraft L and the inertial parameters of the leading aircraft L requested by the following aircraft F and supplied by the inertial reference system 5L of the leading aircraft; and
a reception substep E2c, in which the interrogator 10F of the following aircraft F receives, via the antenna 11F, the response signal which is transmitted to the flight management system 3F which compiles the inertial parameters of the leading aircraft L.

Next, in a decision-making step E3, the flight management system 3F of the following aircraft F estimates/assesses a possibility of the trajectory of the following aircraft F crossing that of the wake vortex (the starboard wake vortex in the example of FIGS. 3a-c), notably following a maneuver of the leading aircraft L which is reflected by a modification of the inertial parameters thereof. The determination is made via a computation of the trajectory of the wake vortex t, then via a comparison of this trajectory to that of the following aircraft. The trajectory of the vortex being computed by the flight management system 3F from a computation of the position of the centers of the vortex and from a computation of prediction of displacement of these centers as a function of the inertial parameters of the leading aircraft L.

If the flight management system 3F determines that the trajectory of the following aircraft F crosses that of the wake vortex, the flight management system 3F modifies the flight plan, and therefore the trajectory of the following aircraft F, in order to set aside any possibility of crossing between the following aircraft F and the wake vortex. The piloting aid system 4F of the following aircraft F follows the modified flight plan and the trajectory of the following aircraft F is modified (FIG. 3c) such that the latter avoids the wake vortex (starboard wake vortex 31 in the example of FIG. 3c).

One of the advantages of the disclosure herein is to ensure that the passengers of the following aircraft F flying in formation behind a leading aircraft L retain an optimal comfort even when the leading aircraft L undertakes a maneuver (deliberate maneuver as a result, for example, of following or modifying the flight plan, or involuntary maneuver as a result, for example, of turbulences/winds) which will modify the trajectories of the wake vortexes that it generates.

For the operations on board the following aircraft F, the implementation of the method for anticipating the displacement of the wake vortexes is transparent because it is totally automated.

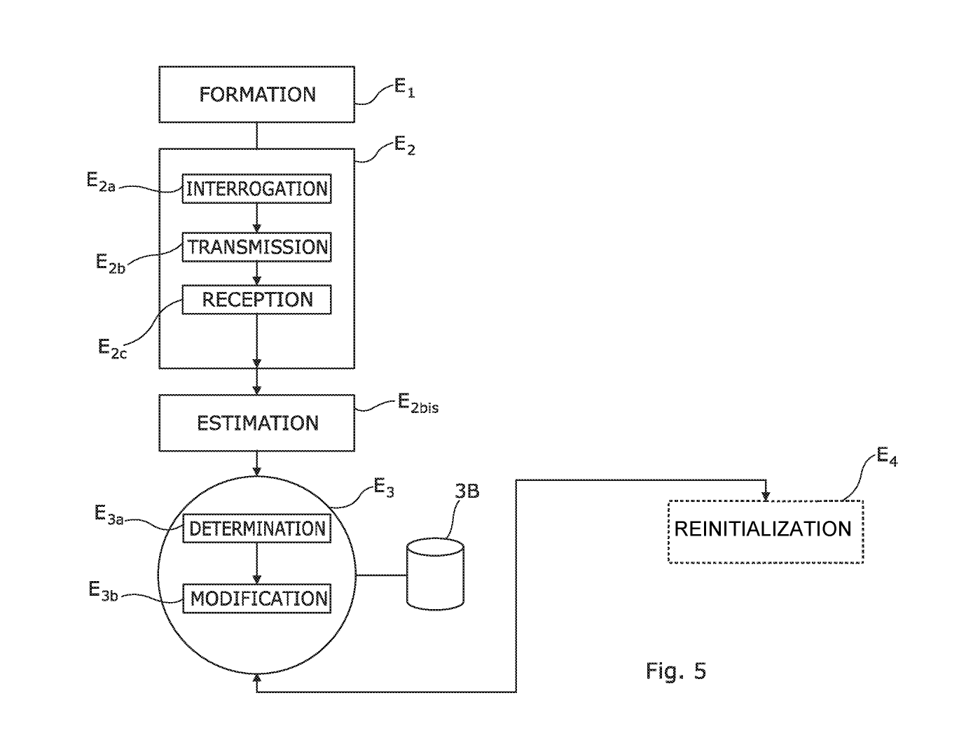

In a variant embodiment of the disclosure herein, the flight management system comprises a database 3B (see FIG. 5) which comprises a decision table that can be used in the case where the aircraft is an aircraft F following a leading aircraft L in a formation flight of two aircraft.

In the decision table, possible different maneuvers of the leading aircraft L are listed (for example: for example turn to the left with a roll angle of 10° and a load factor of 2 g, climb with a trim of 10° and a load factor of 1 g, etc.) and each maneuver of a leading aircraft L has associated with it two predetermined avoidance maneuvers for avoiding crossing the wake vortexes of the leading aircraft L: a first avoidance maneuver in the case where the leading aircraft F benefits from the up draughts of a port wake vortex 30 (that is to say if the following aircraft F flies to the left of the vortex) generated by the leading aircraft L, and a second avoidance maneuver in the case where the following aircraft F benefits from the up draughts from a starboard wake vortex 31 (that is to say if the following aircraft F flies to the right of the vortex) generated by the leading aircraft L.

According to this variant, and referring to FIG. 5, the method as described above is modified in that:
following the step of reception of inertial parameters E2 and before the decision-making step E3, the flight management system 3F of the following aircraft, in an estimation step E2bis, estimates, from the inertial parameters thereof, what maneuver (for example: for example turn to the left with a roll angle of 10° and a load factor of 2 g, climb with a trim of 10° and a load factor of 1 g, etc.) is undertaken by the leading aircraft;
in the decision-making step E3, the assessment is not performed via trajectory computations but via a search for correspondence, performed by the flight management system 3F, between the maneuver of the leading aircraft determined in the determination step E2bis and one of the maneuvers recorded in the decision table of the database 3B.

If no correspondence is found, the flight plan of the following aircraft F is not modified.

If, however, a correspondence is found, the flight management system 3F:
in a determination substep E3a, determines the position of the following aircraft relative to the wake vortexes of the leading aircraft (that is to say determines whether the following aircraft uses the up draughts from the port wake vortex 30 or those from the starboard wake vortex 31); and
in a modification substep E3b, modifies the flight plan to implement the avoidance maneuver associated with the maneuver determined in the determination step E2bis and with the predetermined position of the aircraft and the trajectory of the following aircraft F relative to the wake vortexes of the leading aircraft.

Following this modification substep E3b, the piloting aid system 4F of the following aircraft F follows the modified flight plan and the trajectory of the following aircraft F is modified (FIG. 3c) such that the latter avoids the wake vortex (for example the starboard wake vortex 31 in the example of FIG. 3c).

As an illustration, the decision table can comprise the following avoidance maneuvers, in the case of a formation with two aircraft L and F and in the case of a following aircraft F having its left wing 1F situated at an optimal lateral distance from the center of the starboard wake vortex 31 of the leading aircraft L:

A/ if the leading aircraft L turns with a roll angle of 10° to the right, with a load factor of 2 g, the following aircraft F must turn with a roll angle of 20° to the right with a load factor of 2 g;

B/ if the leading aircraft L turns with an inclination of 10° to the left, with a load factor of 2 g, the following aircraft F must turn with a roll angle of 20° to the right with a load factor of 3 g;

C/ if the leading aircraft L descends with a load factor of −0.1 g and a trim of

−10°, the following aircraft F must climb with a load factor of 0.1 g and a trim of +20°;

D/ if the leading aircraft L descends with a load factor of 0.1 g and a trim of 10°, the following aircraft F must descend with a load factor of −0.1 g and a trim of −20°.

It will be noted that the avoidance maneuvers can have stronger amplitudes than the maneuvers undertaken by the leading aircraft L, and this is so in order to take account of the delay in the transmission of the inertial parameters from the leading aircraft L to the following aircraft F.

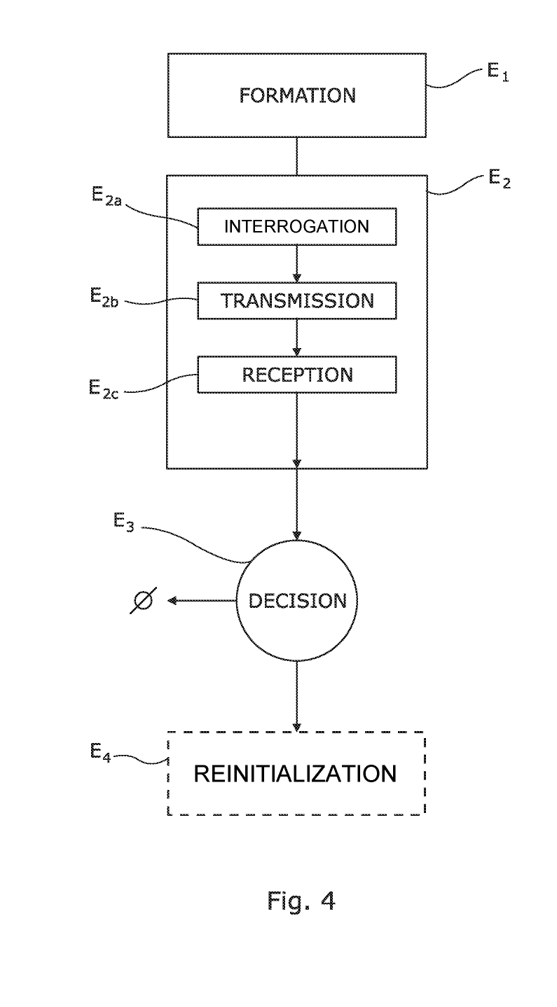

In the methods illustrated in FIGS. 4 and 5, a reinitialization step E4 is preferably implemented at the end of a predetermined time (for example 30 seconds) after the modification of the flight plan in order to avoid crossing the trajectory of a wake vortex 30, 31. In this reinitialization step, the flight management system 3F modifies the flight plan of the following aircraft F to place the latter back in its initial position (see FIG. 3a).

The disclosure herein has been described by considering that the leading and following aircraft communicate via their collision avoidance system of TCAS type for the following aircraft to obtain the inertial parameters of the leading aircraft. Other systems can however be used without departing from the scope of the disclosure herein, for example systems of datalink type, systems of ADS-B type, etc.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for anticipating displacement of a wake vortex generated by a leading aircraft, the method being implemented by a flight management system embedded in a following aircraft flying in a wake of the leading aircraft, the flight management system being configured to compute a trajectory and define a flight plan of the following aircraft from flight parameters of the aircraft, and compute position of centers of the wake vortexes from flight parameters of the leading aircraft, wherein the method comprises successive steps comprising:
a step of establishing formation flight, in which the flight management system of the following aircraft defines a flight plan in which the following aircraft flies at a predetermined distance from the leading aircraft and places itself at a predetermined distance from a center of one of the wake vortexes;
a step of reception of inertial parameters, in which the flight management system of the following aircraft formulates a request for inertial parameters of the leading aircraft and receives, via an exchange of signals between the leading aircraft and the following aircraft, the inertial parameters of the leading aircraft; and
a decision-making step, in which the flight management system of the following aircraft assesses a possibility of the trajectory of the following aircraft crossing a trajectory of the wake vortex:
and wherein, if the flight management system estimates that the trajectory of the following aircraft crosses the trajectory of the wake vortex, the flight management system modifies the flight plan so that the following aircraft avoids the wake vortex.

2. The method according to claim 1, the following aircraft comprising a collision avoidance system configured to detect probabilities of collisions with other aircraft flying with a surveillance system distributed around the aircraft, wherein, in the step of reception of inertial parameters, exchange of signals is performed between the collision avoidance system of the following aircraft and a collision avoidance system of the leading aircraft.

3. The method according to claim 1, wherein, in the decision-making step, the flight management system of the following aircraft computes the trajectory of the wake vortex via the inertial parameters of the leading aircraft and then compares the trajectory of the wake vortex to the trajectory of the following aircraft.

4. The method according to claim 1, the flight management system comprising a database comprising a decision table in which different maneuvers are listed and each maneuver has a predetermined avoidance maneuver associated with it,
wherein, following the step of reception of inertial parameters and before the decision-making step, the flight management system of the following aircraft, in an estimation step, estimates, from the inertial parameters of the leading aircraft, what maneuver is undertaken by the aircraft, and
wherein in the decision-making step, the flight management system searches for a correspondence between the maneuver of the leading aircraft determined in the determination step and one of the maneuvers recorded in the decision table, and
wherein, if a correspondence is found, the flight management system modifies the flight plan by implementing a predetermined avoidance maneuver associated with the maneuver recorded in the decision table such that the following aircraft avoids the wake vortex.
